(19) United States
(12) Patent Application Publication
(10) Pub. No.: US 2002/0044666 A1
(43) Pub. Date: Apr. 18, 2002

(54) Echo suppression device and method for performing the same

(75) Inventors: Alon Eran, Kiryat Ekron (IL); Ofir Mecayten, Netanya (IL)

Correspondence Address: DARBY & DARBY P.C., 805 Third Avenue, New York, NY, 10022, US

(73) Assignee: VOCALTEC COMMUNICATIONS LTD.

(21) Appl. No.: 09/955,745

(22) Filed: Sep. 14, 2001

Related U.S. Application Data
(63) Continuation of application No. PCT/IL00/00152, filed on Mar. 13, 2000.
(60) Provisional application No. 60/124,379, filed on Mar. 15, 1999.

(51) Int. Cl. H04B 3/20; H04R 27/00

(52) U.S. Cl. 381/66; 381/93; 381/83; 379/406.15

(57) ABSTRACT

There is disclosed an audio terminal (10) and a method for operating in uncontrolled audio environments, the audio terminal (10) having an echo suppression unit (20) for reducing acoustic feedback (18). The echo suppression unit (20) includes a learner (22) for learning an audio environment of the audio terminal (10) and a control unit (21) for controlling the acoustic feedback (18) in accordance with the audio environment of the audio terminal (10).

### CROSS REFERENCES TO RELATED APPLICATIONS

This patent application claims priority from U.S. Provisional Patent Application No. 60/124,379, entitled: ECHO SUPPRESSION DEVICE AND METHOD FOR PEWRFORMING THE SAME, filed on Mar. 15, 1999, this U.S. Provisional Patent Application is incorporated by reference in its entirety herein.

### FIELD OF THE INVENTION

The present invention relates to an audio terminal which operates in an uncontrolled audio environment, and in particular, to methods and apparatus associated therewith for echo suppression in uncontrolled environments.

### BACKGROUND OF THE INVENTION

Hands free audio terminals are in common usage today. In order to overcome problems of acoustic feedback, typically a repetition of sounds caused by reflection of sound waves produced in a hands-free audio terminal. This acoustic feedback is typically produced from the reception of sound waves by the audio input device, i.e., microphone, and from sounds originating from the audio output device, i.e., speaker The acoustic feedback can be produced either directly from acoustic coupling or direct paths, or indirectly by reflections off of objects in the surrounding environment. Echo control methods have also been developed to overcome the problems. caused by acoustic feedback. Echo suppression is one technique used for echo control.

Hands free audio terminals may be divided into two types, in accordance with criteria of controllability of the audio environment. Controlled audio environments are those where the entire audio path, from received audio to transmitted audio includes, but is not limited to, the audio amplifiers (constant or not) and input and output audio devices, for example, speakers and microphones. A typical example of such controlled environment hands free audio terminal is a hands free telephone product, or speakerphone. Uncontrolled audio environments occur where some or all of the audio path is left to the user or to an oringal equipment manufacturer (OEM) to configure, typically picking the desired set of speaker, microphone and amplification devices. A typical example of such uncontrolled environment hands free audio terminal is a PC-based audio terminal application, were the amplification is determined by the PC sound card and the microphone/speaker combination. These combinations may include microphones of extremely high gain, that can generate an acoustic feedback.

Echo suppressing devices have been developed to alleviate acoustic feedback problems by means of controlling the relative attenuation of the separate audio paths. Echo suppression by these devices involves monitoring audio activity on both audio paths of the hands free audio terminal to decide the proper operative state for the terminal. The terminal typically includes a state machine for controlling terminal operation in one of three states, a play state, a record state, and an idle state.

In the play state, the dominant audio exits the speaker, with the exiting audio having priority over any audio going into the microphone. In the record state, the dominant audio goes into the microphone and is given priority over the audio exiting the speaker. In the idle state, both audio paths are inactive or their relative activity levels match. Depending on the state selected, echo suppression involves implementing an attenuation strategy that effectively weakens the signal of the lower priority channel. This results in the elimination of the acoustic feedback from the audio path connected to the microphone.

When these echo suppressors were used in controlled environment hands free telephones (HFT), they performed suitably. This is because the hardware specifics in these HFTs are either constant or known to the echo suppression device making the decision as to states or a controlled environment in HFT. On the other hand, echo suppressors implemented in uncontrolled environment settings do not have the benefit of the “knowledge” of these important hardware parameters.

For example, when the audio terminal is a personal computer (PC) based, applications for the audio environment of the audio terminal may differ from installation to installation and from invocation to invocation of the software application. Accordingly, these PC-based echo suppressors cannot rely on absolute signal ratings from signal sources for making state decisions. This is because the microphones and the speakers, coupled with PCs from various venders, comprise different gains from various spatial combinations. Rather, these applications rely on relative ratings between two audio streams, a first or “play” state audio stream from the end of the distant user, and a second or “record” state audio stream coming from the end of the local user.

When a new installation is made, the echo suppressor has to perform an algorithm to adapt to the new characteristics of the installation. These algorithms typically evaluate energy statistics, with the requisite convergence time needed to evaluate the energy being approximately 5-6 minutes, too long to give satisfactory operation within the scope of a typical audio terminal session. This convergence time is long, due to the need of a significant time span of active speech, that is needed from both audio streams in order to reach a correct recognition of the type of audio environment in which the echo suppressor is operating. Moreover, in the specific case of a microphone having extremely high gain, the accumulation of active speech time on the play audio path may take an indefinite amount of actual time. This is because the echo suppression controller never recognizes any greater amount of activity in the play path relative to the record path.

### SUMMARY OF THE INVENTION

The present invention overcomes the problems with conventional PC-based audio terminal applications by learning the audio environment and recognizing microphones with extremely high gain, based on timings from the echo suppressor, rather than qualities inherent in the signal from it. By timing echo suppressor states, a recognition decision can be made quickly, for example, in approximately 5-6 seconds as opposed to 5-6 minute convergence time, associated with energy statistics methods. As a result, a decision can be made shortly into the audio terminal session, such that the session can proceed at sufficient conversation quality.

The present invention provides an echo suppression mechanism for uncontrolled audio environments. The present invention provides an audio terminal and a method for recognizing extreme cases of audio environments, and based on timings and energy measurements taken over a short period of time, typically the first few seconds of a conversation. The echo suppression mechanism of the present invention can adjust receive and transmit streams of an audio terminal, e.g., a speakerphone, to compensate for the microphone type.

In one aspect of the present invention, there is provided an audio terminal for operating at uncontrolled audio environment. The audio terminal includes an echo suppression unit for reducing an acoustic feedback. The echo suppression unit includes a learner for learning an audio environment of the audio terminal; and a control unit for controlling the acoustic feedback in accordance with the audio environment of the audio terminal.

The echo suppression unit also includes a state machine which can accommodate at least each of one transmit state, receive state, or an idle state. The learner includes a timing learner for measuring times of an active audio in each one of the receive state and transmit state of said state machine for providing a first index to the control unit; and an energy learner for measuring energies of an active audio in each one of the receive state and transmit state of the state machine for providing a second index to the control unit.

Preferably, the control unit includes energy estimators for measuring an audio energy of each one of the receive audio stream and transmit audio, and for providing measurements to the energy learner, an attenuation table being updated by the energy learner and the timing learner for providing attenuation values to an attenuation unit for adjusting the receive and transmit stream attenuations in accordance with the attenuation values.

In this manner, the control unit further includes a decision unit for receiving signals corresponding to an audio activity at the receive and transmit streams from the energy estimate units. Receiving at least one value for a threshold table for providing a signal corresponding to a voice activity decision and a state memory, and a hangover logic unit for receiving the voice activity decision and providing a state machine index to the attenuation table which provides at least one attenuation parameter to the attenuation unit in accordance with the audio terminal state machine state.

In another embodiment of the present invention, the uncontrolled audio environment includes at least one of the following parameters: a random distance between the audio terminal input device and out put device, a random distance between an audio source to each one of said audio terminal input device and output device, a valve accommodating ambient environmental noise and the technical specifications of a plurality of audio components of the audio terminal.

In the second aspect of the present invention, there is provided an echo suppression unit for reducing acoustic feedback which is generated in an uncontrolled audio environment. The echo suppression includes a learner for learning the uncontrolled audio environment and a control unit for controlling said acoustic feedback in accordance with the uncontrolled audio environment identification.

Preferably, the echo suppression includes a state machine that can be at least in one of a transmit state, a receive state and an idle state, and the learner. The learner includes a timing learner for measuring a time of an active audio in each one of the receive state and transmit state of the state machine for providing a first index to the control unit; and an energy learner for measuring an energy of an active audio in each one of the receive and transmit states of the state machine, for providing a second index to the control unit.

In this embodiment of the present invention, the control unit of the echo suppression includes energy estimators for measuring an audio energy of each one of the receive audio stream and transmit audio and for providing measurements to the energy learner and an attenuation table being updated by the energy learner and the timing learner for providing attenuation values to an attenuation unit for adjusting the receive stream and transmit stream attenuation with accordance with the attenuation values.

In this manner, the control unit further includes a decision unit for receiving signals corresponding to an audio activity at the receive and transmit streams from the energy estimators, receiving at least one value from a threshold table for providing a signal corresponding to a voice activity decision and a state memory and hangover logic unit for receiving the voice activity decision and providing a state machine index to the attenuation table which provides at least one attenuation parameter to the attenuation unit in accordance with the state of the echo suppression state machine. In a third aspect of the present invention a learner for learning the audio parameters of an uncontrolled audio environment is provided. The learner includes a timing learner for measuring a time of an active audio of an audio stream for providing timing parameters, and an energy learner for measuring an energy of active audio of an audio stream for providing an energy parameters wherein, a combination of the timing and energy parameters provides an indication of the type of uncontrolled audio environment.

The timing learner includes at least one timer for measuring a time of active audio presence on at least one audio stream, means for processing said at least one timer measurements and a decision logic unit. The decision logic unit receives processed time parameters and an audio environment parameter for providing an indication of a type of said uncontrolled audio environment.

In another embodiment of the present invention, the energy learner includes means for receiving audio energy measurements, means for processing the energy measurements and a decision logic unit. The decision logic unit receives processed energy parameters and audio environment parameters for providing an indication of a type of the uncontrolled audio environment.

The learner of the present invention operates in a predetermined time frame and ceases functioning when each decision logic unit of each of the timing learner and the energy learner reaches a decision.

In a forth aspect of the present invention, there is provided a method of controlling an acoustic feedback of an audio terminal having a plurality of audio states which include at least a transmit audio state, at least a receive audio state, and at least an idle audio state. The method includes the steps of: providing a first learner for learning the timing characteristics of the receive and transmit states for providing a first index, providing a second learner for learning the energy characteristics of the receive and transmit states for providing a second index, manipulating the first index with said second index for identifying a type of uncontrolled audio environment of the audio terminal and controlling the acoustic feedback of the audio terminal in accordance with the identification.

In this manner, the step of controlling further includes the steps of: setting the audio terminal in at least one state of the audio terminal state machine, tuning the attenuators in accordance with the audio environment, transitioning to at least one other state of the audio terminal state machine and repeating the steps of tuning and transitioning for each state.

In another embodiment of the present invention, the audio terminal parameters include at least the parameters of: a discrimination threshold between audio stream activity/energy ratios, a set of attenuation values for the various states of the state machine used on the receive and transmit audio streams and the hangover timings between state transitions of said audio terminal state machine.

### BRIEF DESCRIPTION OF THE DRAWINGS

The present invention will be understood and appreciated more fully from the following detailed description taken in conjunction with the appended drawings in which:

FIG. 1 is a diagram of an audio terminal of the present invention;

FIG. 2 is a diagram of the control unit of FIG. 1;

FIG. 3 is a diagram of a timing learner in accordance with the present invention;

FIG. 4 is a diagram of an energy learner in accordance with the present invention;

FIG. 5 is a chart of a state machine in accordance with the present invention;

FIG. 6 is an example attenuation table in accordance with the present invention;

FIGS. 7a-7c are graphs from which the threshold tables were constructed in accordance with the present invention;

FIG. 8 is a flow chart illustrating the methods employed by decision logic components of FIG. 2 in accordance with the present invention;

FIG. 9 is a flow chart illustrating the methods employed by the state memory and hangover logic components of the present invention;

FIG. 10 is a flow chart of the decision logic of the timing learner of FIG. 3, in accordance with the present invention; and

FIG. 11 is a flow chart of the decision logic of the energy learner of FIG. 4, in accordance with the present invention.

### DETAILED DESCRIPTION OF THE PRESENT INVENTION

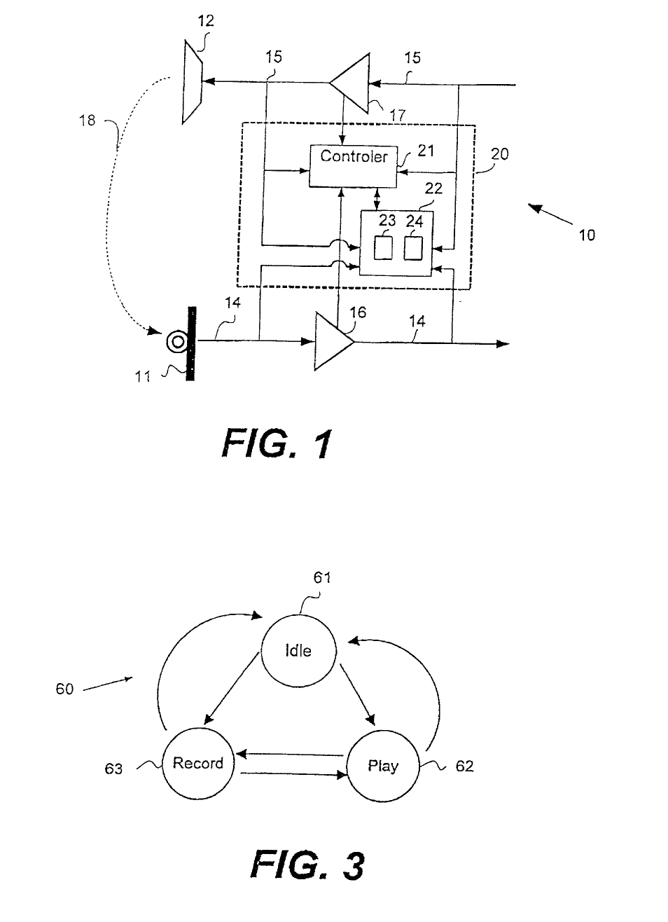

FIG. 1 details an audio terminal 10 of the present invention. The audio terminal 10 includes a microphone 11 and a speaker 12, both electronically linked to an echo suppression unit 20 which includes a suppressor (not shown). The microphone 11 is the input for a receive stream 14 and the speaker 12 is the output for a transmit stream 15. A receive stream amplifier 16 and a transmit stream amplifier 17, preferably serve as stream attenuators, and are placed along the receive and transmit stream 14, 15 respectively. Amplifiers 16 and 17 are in communication with the microphone 11 and speaker 12 respectively. An acoustic feedback 18, which is shown by a dotted line, is typically generated between the speaker 12 and the microphone 11. The echo suppression unit 20 includes a control unit 21 and a learner 22. The learner 22 is operably coupled to the receive stream 14 and to the transmit stream 15 for learning the audio parameters of those streams. The learner 22 of the present invention includes a timing learner 23 and an energy learner 24, and is further coupled to the control unit 21. The control unit 21 exchanges timing and energy parameters of audio with the learner 22 and controls the echo suppression unit 20 operation, accordingly.

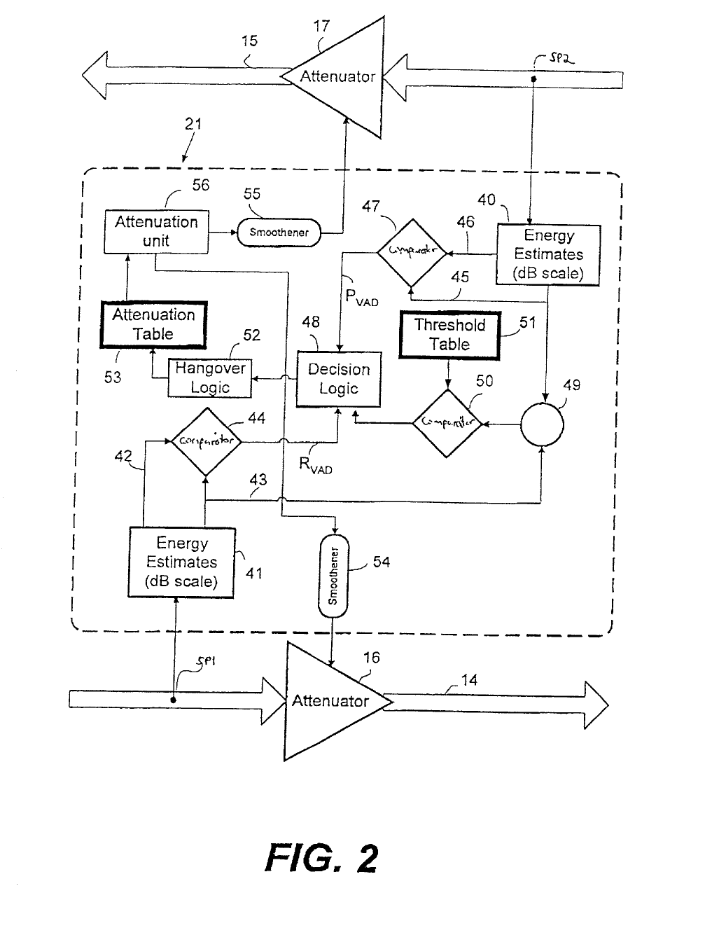

FIG. 2 shows the control unit 21, where there is detailed the structure and the methods in accordance with the present invention. The control unit 21 includes energy estimates (boxes 40, 41) for taking energy measurements of audio. The measurements are taken simultaneously or close in time to each other, preferably by sampling the respective receive stream 14 and transmit stream 15, at the respective sample points SP1, SP2. The receive stream energy estimate (box 41), provides the outputs of long term energy estimates 42 and short term energy estimates 43 to a comparator 44. The transmit stream energy estimate (box 40) provides the outputs of long term energy estimates 46, and short term energy estimates 45 to a comparator 47.

The comparison preferably involves: 1) comparing the short term energy estimate to the long term energy estimate for both the receive and transmit streams; and 2) determining if the voice is active or inactive. The outputs from the respective comparators 44, 47 are signals corresponding to low level audio activity on transmit and receive streams and which were input into the decision logic box 48.

In an exemplary algorithm, these comparisons may be expressed as:

Eₛ—a short term energy estimate; and

Eₙ—a long term energy estimate

IF (Eₛ>Eₗ*10^{0.9})

THEN R_{VAD}=TRUE (voice is active)

ELSE R_{VAD}=FALSE (voice is not active)

These low level energy decisions are then input into the decision logic (box 48), from the receive stream 14 as R_{VAD}, and from the transmit stream 15 as P_{VAD}. VAD stands for Voice Activity Detection which this comparison emulates to some extent. The VAD that was described above is an energy VAD. Other type of VADs may be used as additional or instead the preferred embodiment VAD.

The short term estimates 43, 45 may be performed by hardware or software or combinations of both, that perform the following algorithm:

Es (new)=αEₛ(old)+(1−α)Sₙ²

Eₗ(new)=

If Sₙ>Eₗ (old) then β_{Attack} Eₗ (old)+(1−β_{attack})*Sₙ

If Sₙ>Eₗ (old) then β_{decay} Eₗ (old)+(1−β_{decay})*Sₙ

Where,

Sₙ—sampled energy from audio stream,

Eₛ—short term energy estimate from energy sample, and

Eₗ—long term energy estimate from energy sample.

β_{attack}-Attack slope coefficient, and

β_{decay}-Decay slope coefficient.

These long term and short term energy estimates are then formed into an energy ratio (EnR), typically of transmit energy over receive energy, by conventional software, hardware or combinations thereof, at a divider, box 49. This energy ratio is then compared by a comparator 50 to a pair of values from a threshold table 51. The result of the above comparison is input into decision logic (box 48). When there is an active voice on a receive stream, the echo suppression unit 20 is in a record state. When there is an active voice on the transmit stream the echo suppression unit 20 is in a play state. Within the decision logic, box 48, the inputs RVAD, PVAD and EnR are subjected to an exemplary algorithm below. This exemplary algorithm may be performed by hardware, software or combinations of both.

IF (R_{VAD}==TRUE and EnR<RecThresh)

THEN PRstate=RECORD

ELSE IF (P_{VAD}==TRUE and EnR>PlayTresh)

THEN PRstate=PLAY ELSE PRstate =IDLE

where:

RecThresh—is the lower bound on the Play-Record ratio for the selected microphone;

PlayThresh—is the upper bound on the Play-Record ratio; and

PRstate—is the outcome of proposed state.

The exemplary algorithm is outputted as a signal corresponding to a proposed state, that is sent to State Memory and Hangover Logic, box 52. The hangover logic compares the output from the decision logic (box 48) to a current state of operation of the echo suppression unit 20 of audio terminal 10 and outputs an index into an attenuation table 53. If the decision was that the audio terminal 10 should hangover from the current state for example, receive state, to the next state, for example a transmit state, then the attenuation table 53 provides the gains to adjust the attenuators 16, 17 to an attenuation unit 56. The attenuation unit 56 adjusts attenuators 16, 17 through smoothers 54, 55 in accordance with the attenuation values of the attenuation table 53.

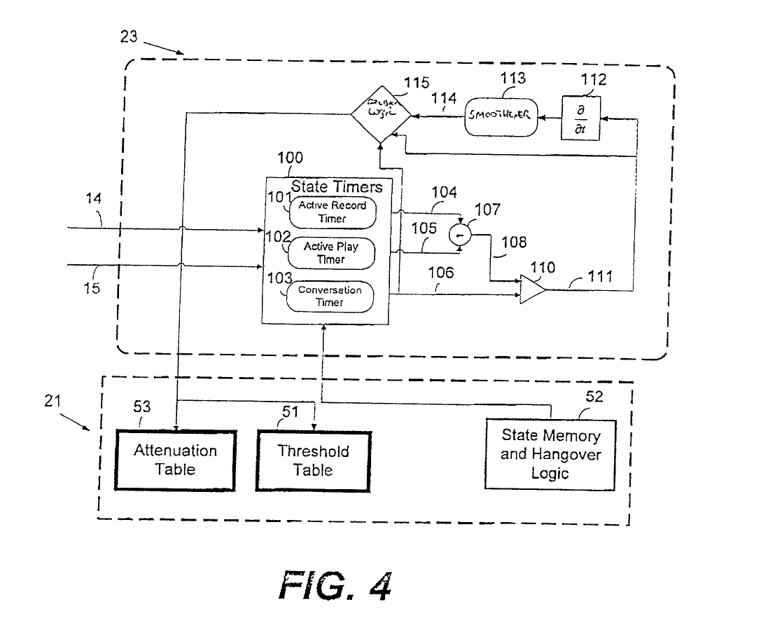

Referring now to FIG. 3, a state machine 60 of the echo suppressor 20 is shown. The state machine 60 preferably has at least three states, an idle state 61, a play state 62 and a record state 63. The echo suppression 20 of the audio terminal 10 may be in one of those states and may move from idle state 61 to record state 63 or play state 62; from play state 62 to record state 63 or idle state 61; and from record state 63 to play state 62 or idle state 61. In the idle state 61, there is not any audio on the receive and transmit audio streams 14, 15. The record state 63 occurs when there is audio energy on the receive stream 14, and the play state 62 occurs when audio energy is present in the transmit stream 15.

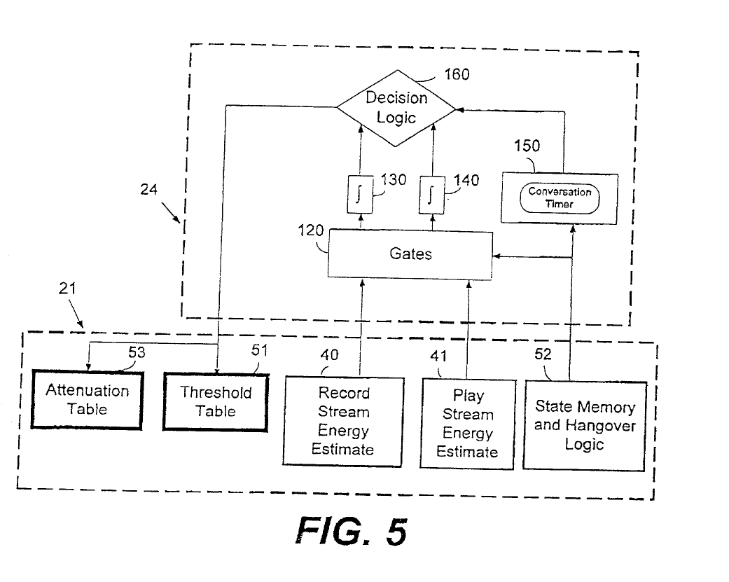

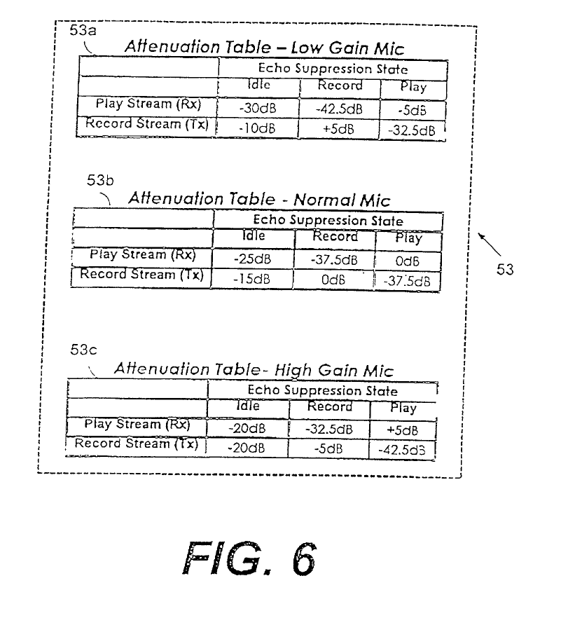

A detailed description of the learner unit 22 is now provided with reference to FIGS. 4 and 5. The learner unit 22 preferably includes a first learner for learning timing characteristics of the receive and transmit states for providing a first index to the control unit 21 and a second learner 24 for learning the energy characteristics of the receive and transmit states for providing a second index to the control unit 21. The first learner is a timing learner 23 and the second learner in an energy learner 24. The control unit 21 is for manipulating the first index with respect to the second index for identifying an audio environment of the audio terminal 10. The control unit 21 controls the acoustic feedback of the audio terminal in accordance with the identification.

The learners 23, 24 provide indexes which are employed to select particular values in the threshold table 51 and the attenuation table 53, corresponding to microphone sensitivity detected thereby. The energy learner 24 serves to potentially override the decision from the timing learner 23 should the requisite conditions exist, as detailed below. These learners 23, 24 are linked to the State Memory and Hangover logic 52 in their operation. The time frame of operation of these learners 23, 24 is limited to the initial part of the audio terminal 10 session. After each learner 23, 24 reaches a decision, it is preferably designed to cease functioning.

A detailed description of the timing learner 23 operation will be given now with reference to FIG. 4. The timing learner 23 utilizes state machine decisions from the state memory and hangover logic, box 52. The state timers, box 100, measure the time of playing audio from the transmit audio stream 15 and the time of recording from the receive audio stream 14. The echo suppression unit 20 includes the state machine 60, which is typically in one of a record state 63, play state 62 or idle state 61. The state timers, box 100, include an active record timer 101, for timing active audio presence at the record state 63, an active play timer 102, for timing the active audio presence at the play state 62, and a conversation timer 103, for timing the conversation, preferably the active speech of the conversation. Each of the above mentioned timers generates an output 104, 105, 106. Active Record timer output 104 and active play timer output 105 are inputted into a subtractor 107, that gives the simultaneous difference between accumulated state timings as output 108. Output 108 is time normalized by output 106 in a division block 110, resulting in an output 111. Preferably, approximately ten seconds of session time must pass for a correct decision to be reached.

Output 111 goes through a differentiator 112, typically a low order high pass filter, and then through a smoothener 113, in accordance with those detailed above. The output 114 from the smoothener 113, along with outputs 106 and 111 are input into decision logic, box 115. This decision logic, box 115, provides a reference index into both the threshold table 51 and attenuation table 53 to be used for making echo suppression decisions during steady state operation of an audio terminal 10 in an uncontrolled environment.

FIG. 5 shows the energy learner 24. Signals from the State Memory and Hangover Logic, box 52, the receive stream energy estimate 40, and the transmit stream energy estimate 41 are input into gates, box 120. These gates are such that the play energy input is only received when the play state 62 is active and the record energy input is only received when the record state 63 is active.

Integrators 130, 140 for the outputted values corresponding to the record and play energies, respectively, function to average the inputted energies, so as to give a temporary estimate of the average energy in the receive or transmit stream, it its active state only. Outputs, from the respective integrators 130, 140 and conversation timer 150, that receives a signal from the State Memory and Hangover Logic, box 52, are input into the decision logic, box 160. The decision generated by the decision logic, box 160, is similar to that of the decision logic (box 115) for the timing learner 23.

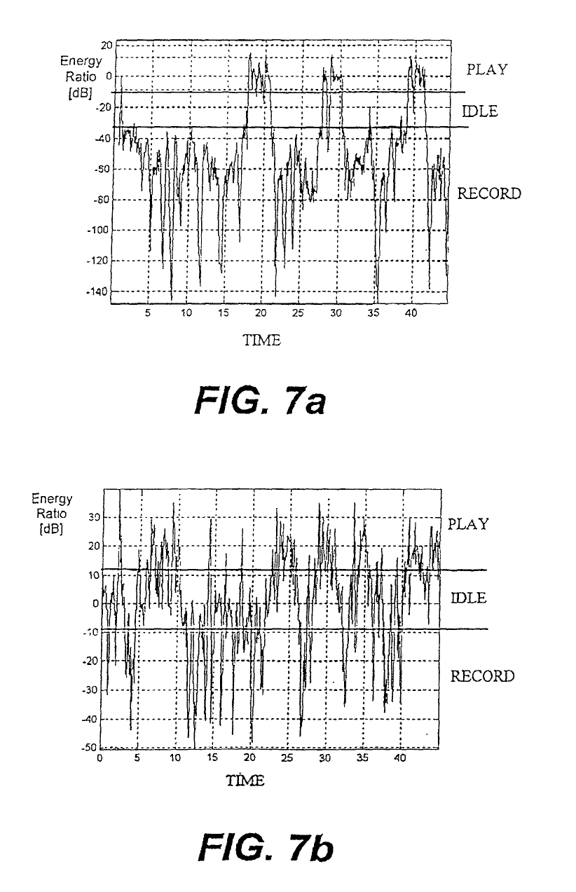

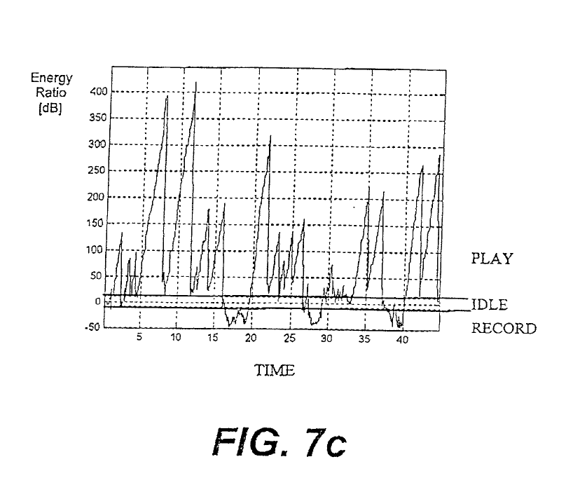

An example of the attenuation table 53 is illustrated in FIG. 6. The attenuation table 52 is established from predetermined values, determined by isolating levels that are approximately the local maxima and local minima. The local maxima and minima are corresponding to the IDLE bands, between the upper PLAY zone and the lower RECORD zone, of the play-to-record energy ratios during conversation. These energy ratios are for microphone sensitivities, that are of the high gain type (FIG. 7a), the nominal gain type (FIG. 7b), and the low gain type (FIG. 7c). The upper and lower boundaries for the IDLE band correspond to the values of the threshold table 51, with the determination of the microphone sensitivity, from which the values for the comparison by comparator 50 will be taken, made initially in the timing leaner 23 and potentially changed by a signal received from the energy learner 24.

The attenuation table 53 is actually a series of subtables tables 53a-53c, based on the microphone type (high gain, nominal, or low gain) designed for use in the present invention.

The attenuation table 53, in particular, the subtables 53a-53c, were determined experimentally. Specifically, the attenuation subtable 53b suitable for the nominal microphone was determined by tuning attenuation values provided by Motorola, Inc., in “Voice Switched Speakerphone with Microprocessor Interface (Semiconductor Technical Data)”, Publication MC33218A, this publication incorporated by reference in its entirety herein. A suitable range for these values is +/−6 dB, corresponding to quarter power, and may be selected for attenuation subtables 53a and 53c. The preferred attenuations are +/−5 dB from the attenuation values of subtable 53b, hence, in attenuation subtable 53a, the values are increased by 5 dB, and in attenuation subtable 53c, the values are decreased by 5 dB. While these values are suitable for the present invention, the skilled artisan could easily tune these values to arrive at those needed for their requisite practicing of the present invention.

The State Memory and Hangover logic box 52, sends signals in accordance with the valves from the attenuation table 53, to select amplifier values based on the selected state and microphone type, the microphone type determined from the timing learner 23 and energy learner 24. The attenuation table 53 then send signals corresponding to the set point attenuation to the attenuation unit 56, through smootheners 54, 55, to adjust the gains of amplifiers 16, 17 of the receive 14 and transmit 15 streams. These smootheners 54, 55 are typically filters, that serve to permit smooth transitions between set points. The set point attenuation signal, from the attenuation unit 56, provides signals for adjusting the amplifiers 16, 17 of the receive 14 and transmit 15 streams.

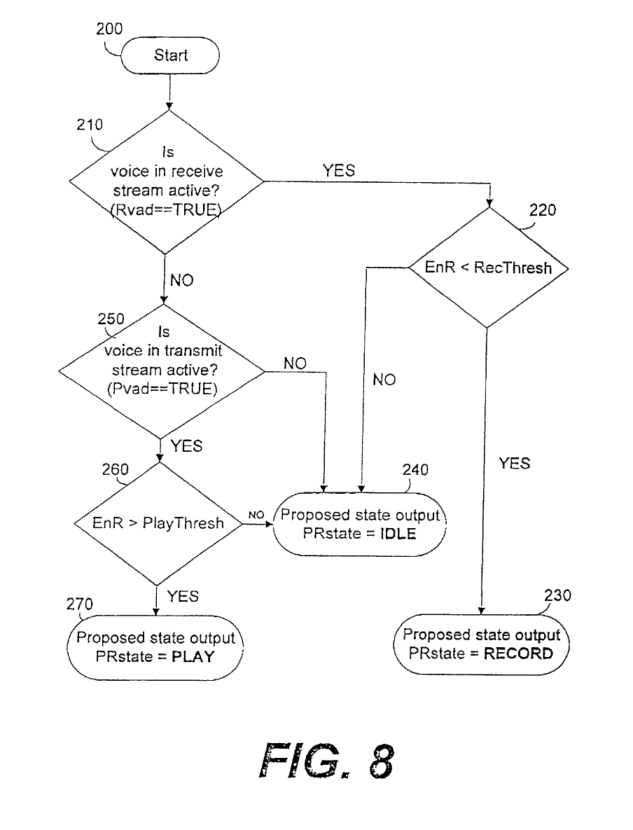

FIG. 8 details the functioning of the comparator 50 and the decision logic, box 48 of FIG. 2 Initially, from the respective low level activity decisions of both the receive and transmit streams, it is first determined if the voice in the receive stream is active (block 210). This is expressed algorithmically as RVAD=TRUE. If, YES. a comparison between the energy ratio (EnR) and the values for the selected microphone sensitivity for the record threshold (RecThresh) is made (block 220) If the energy ratio (EnR) is less than the Record Threshold (RecThresh) the Proposed State Output (PRₛₜₐₜₑ) is RECORD, as shown at block 230 Otherwise, the Proposed State Output (PRₛₜₐₜₑ) is IDLE, as shown at block 240.

If the voice is not active in the receive stream (R_{VAD}=FALSE). voice activity in the transmit stream is analyzed, at block 250. If there is voice activity in the transmit stream (P_{VAD}=TRUE), a comparison between the energy ratio (EnR) and the values for the selected microphone sensitivity for the play threshold (PlayThresh) is made, at block 26 If the energy ratio (EnR) is greater than the Play Threshold (PlayThresh) the Proposed State Output (PRₛₜₐₜₑ) is PLAY, as shown at block 270. Otherwise, the Proposed State Output (PRₛₜₐₜₑ) is IDLE, as shown at block 240. Finally, if there is not voice activity in the transmit stream, the Proposed State (PRₛₜₐₜₑ) is IDLE. as shown at block 240.

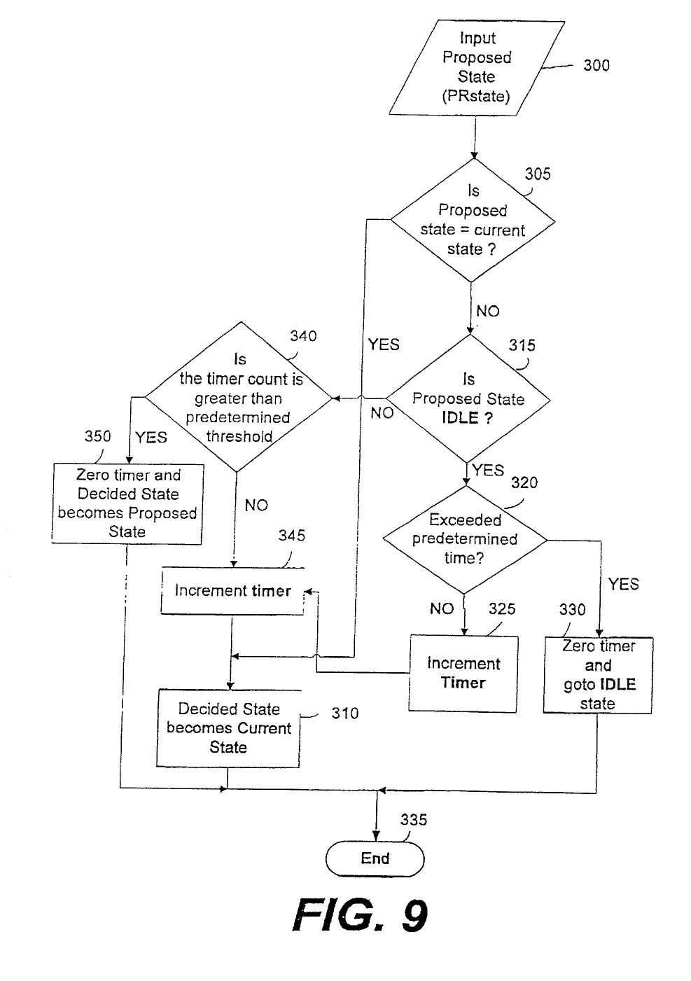

Referring to FIG. 9, there is shown an algorithm for making determinations for state changing by the state machine of FIG. 5 The decision logic 48 of FIG. 2 provides a proposed state, block 300. It is first determined if the proposed state is the current state at block 305. If YES, the decided state is (remains) the current state, block 310. The process cycle ends at block 335, until the next interval.

If the proposed state is not the current state. it is determined if the proposed state is the IDLE state, at block 315. If YES a determination is made if the counter has exceeded a predetermined amount of time, for example, approximately 0.5 seconds, at block 320. If NO, the idle transition hangover is incremented by the time interval (less than approximately 0.5 seconds), at block 325 and the decided state is (remains) the current state, block 310. If YES, the counter is set to 0 (zero) and the state machine 60, is set to the IDLE state 61, at block 330, with the state machine 60 moving to the IDLE state 61 in a slow transition with a long hangover of approximately 0.5 seconds, indicated by the curved arrows. The process ends at block 335, until the next interval.

If the proposed state is not IDLE, the state is either PLAY or RECORD. It is then determined if the time of the state inversion hangover is greater than a predetermined threshold, for example approximately 50 ms, at block 340. If NO, this predetermined threshold has not been met and the state inversion hangover is incremented by the amount of time of the interval, at block 345. The decided state is (remains) the current state, block 310. If YES, block 350 is applicable and the state inversion hangover is set to 0 (zero) and the state machine 60, is moved to either the RECORD 63 or PLAY 62 state set in a fast transition with a short hangover, approximately 50 ms, indicated by straight arrows at FIG. 3. With the state changed, the process ends at block 335 until the next interval.

The methods of FIGS. 8 and 9 are performed in intervals. As many intervals as necessary, typically over the operational period, e.g., the conversation, of the speakerphone or the like, are permissible.

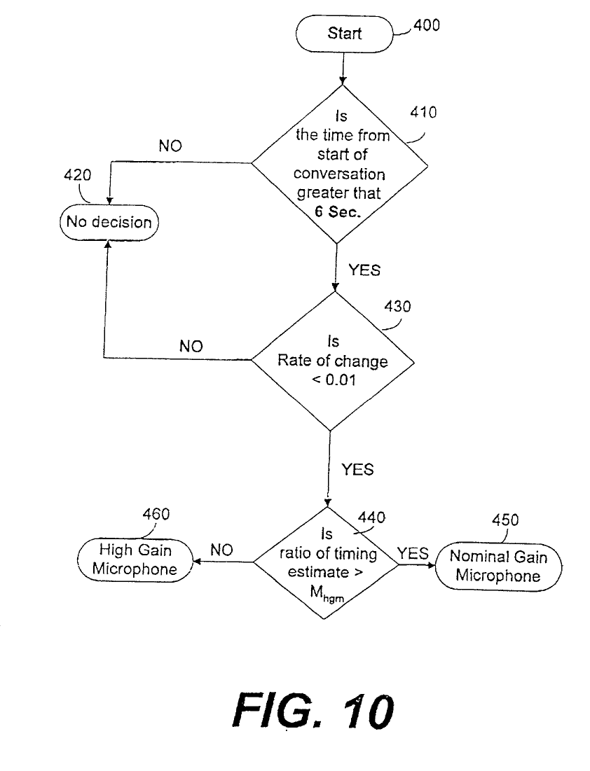

FIG. 10 details an exemplary method employed by the decision logic 115 of timing learner 23, illustrated in FIG. 4, through software, hardware or combinations of both. The output 114 from the smoothener 113 is the initial starting point, block 400. At block 410, the actual time from the start of the conversation is analyzed, and if it is less than six seconds, a decision is not made yet (block 420). If the actual time of the conversation is greater than 6 seconds, a rate of change for the timing estimates is compared to a rate of change threshold (RTH) at block 430. An exemplary value for the rate of change threshold (RTH) is typically approximately 0.01. If the rate of change from the division block output 111 and the smoothener output 114 is greater than 0.01, the value for the rate of change threshold (R_{TH}) is such that a decision can not yet be made (block 420). If the rate of change from the division block output 111 and the smoother output 114 is less than 0.01 for R_{TH}, the ratio of timing estimates to elapsed time of the conversation timer 103, output 106 (this value being a percentage) from box 100 (FIG. 4), is compared with the minimum percentage difference required for a high gain microphone (hgm) decision (Mhgm) at block 440. If this ratio of timing estimates is less than 30%, the microphone decision is to keep the current microphone settings. Alternately, if this ratio is greater than 30%, the microphone decision is to increase by one in the settings ladder, with a low gain microphone type being upgraded to a nominal microphone type and a nominal gain microphone type being upgrade to a high gain microphone type.

If a microphone type is not specified from a previous determination, the nominal microphone type is the default. This applies to all microphone type settings for the present invention.

The algorithms detailed create values based on three states: play, record and idle, corresponding to the three respective states (PLAY 62, RECORD 63, IDLE 61) of the state machine 60, shown in FIG. 3. These algorithms are exemplary only, as the state machine can be modified with additional states such that the present invention may accommodate these additional states.

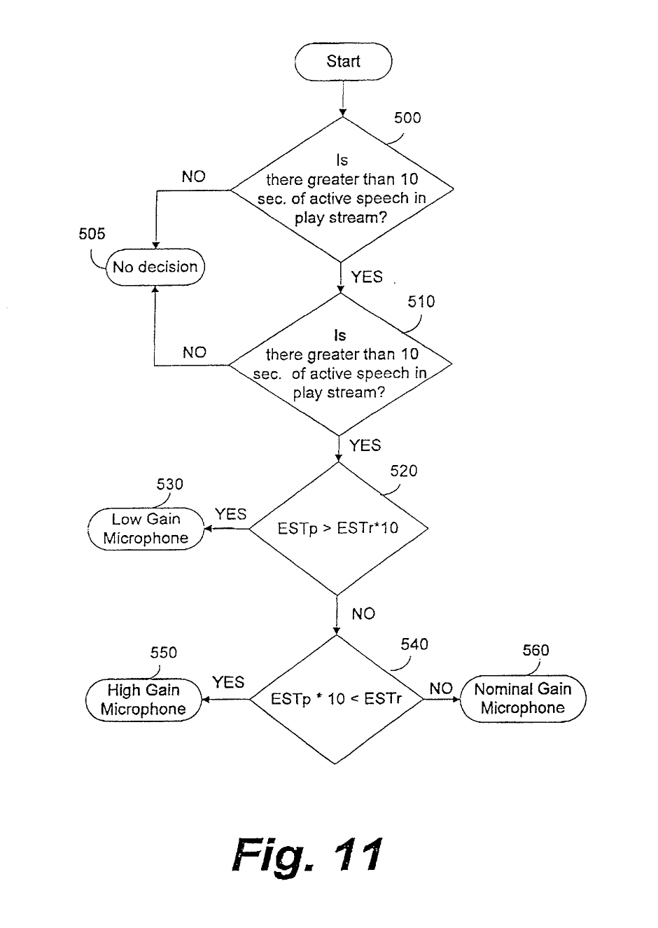

FIG. 11 details a method for determining a microphone sensitivity as employed by the decision logic of the energy learner 22 which is illustrated in FIG. 4, through software, hardware or combinations of both. Initially, the transmit stream 15 is timed, such that there is more than 10 seconds of active speech therein, at block 500. If not, a decision cannot be made (block 505). If the transmit stream 15 has had more than 10 seconds of active speech, the active speech in the receive stream 14 is evaluated, at block 520. If the receive stream 14 has had more than 10 seconds of active speech, a first energy comparison is made, at block 520, of short term play energy (ESTP) and the short term record energy (ESTᵣ) are compared. If, the relation: ESTₚ>ESTᵣ*10e, then the microphone is a low gain microphone (block 530). If not, a second energy comparison of the short term energies is made at block 540. Specifically, if ESTₚ·10e<ESTᵣ, then the microphone is high gain (block 550) and if not, the microphone is nominal gain (block 560).

While preferred embodiments of the present invention have been described so as to enable one of skill in the art to practice the present invention, the preceding description is exemplary only, and should not be used to limit the scope of the invention. The scope of the invention should be determined by the following claims.

1. An audio terminal for operating at uncontrolled audio environment having an echo suppression unit for reducing an acoustic feedback, wherein said echo suppression unit comprising:
a learner for learning an audio environment of said audio terminal; and
a control unit for controlling said acoustic feedback in accordance with said audio environment of said audio terminal.

2. The audio terminal of claim 1, wherein said echo suppression unit further includes a state machine which can be at least in one of a transmit state, a receive state and an idle state, and wherein the learner comprises:
a timing learner for measuring a time of an active audio in each one of the receive state and transmit state of said state machine for providing a timing index to said control unit; and
an energy learner for measuring an energy of an active audio in each one of the receive state and transmit state of said state machine for providing an energy index to said control unit.

3. The audio terminal of claim 1, wherein said control unit comprises:
At least two energy estimators for measuring an audio energy of each one of the receive audio stream and transmit audio stream for providing measurements to said energy learner;
an attenuation table being updated by said energy learner and said timing learner for providing attenuation values to an attenuation unit for adjusting receive stream and transmit stream amplifier in accordance with said attenuation values.

4. The audio terminal of claim 3, wherein the control unit additionally comprises:
a decision unit for receiving signals corresponding to an audio activity at said receive and transmit streams from said energy estimates units, receiving at least one value from a threshold table for providing a signal corresponding to an voice activity decision; and
a state memory and hangover logic unit for receiving said voice activity decision and providing an state machine index to said attenuation table which provides at least one attenuation parameter to said attenuation unit in accordance with said audio terminal state machine state.

5. An echo suppression unit for reducing acoustic feedback comprising:
a learner for learning an audio environment of said audio terminal; and
a control unit for controlling said acoustic feedback in accordance with said audio environment of said audio terminal.

6. The echo suppression unit of claim 5, additionally comprising:
a state machine configured for at least one of a transmit state, a receive state and an idle state; and
wherein said learner comprises:
a timing learner for measuring a time of an active audio in each one of the receive state and transmit state of said state machine for providing a first index to said control unit; and
an energy learner for measuring an energy of an active audio in each one of the receive state and transmit state of said state machine for providing a second index to said control unit.

7. The echo suppression unit of claim 5, wherein said control unit comprises:
at least two energy estimators for measuring an audio energy of each one of the receive audio stream and transmit audio and for providing measurements to said energy learner; and
an attenuation table being updated by said energy learner and said timing learner for providing attenuation values to an attenuation unit for adjusting receive stream and transmit stream attenuation with accordance to said attenuation values.

8. The echo suppression unit of claim 7, wherein said control unit further comprises:
a decision unit for receiving signals corresponding to an audio activity at said receive and transmit streams from said energy estimates units, receiving at least one value from a threshold table for providing a voice activity decision; and
a state memory and hangover logic unit for receiving said voice activity decision and providing a state machine index to said attenuation table which provides at least one attenuation parameter to said attenuation unit in accordance with said echo suppression state machine state.

9. A learner for learning audio parameters of an uncontrolled audio environment comprising:
a timing learner for measuring a time of an active audio of an audio stream for providing a timing parameters; and
an energy learner for measuring a time of an active audio of an audio stream for providing an energy parameters wherein a combination of said timing and energy parameters provides an indication of a type of said uncontrolled audio environment.

10. The learner of claim 9, wherein said timing learner comprises:
at least one timer for measuring a time of active audio presence on at least one audio stream;
means for processing said at least one timer measurements; and
a decision logic unit for receiving a processed timer parameters and audio environment parameter for providing an indicator or a type of said uncontrolled audio environment.

11. The learner of claim 9, wherein said energy learner comprises:
means for receiving audio energy measurements;
means for processing said energy measurements; and
a decision logic unit for receiving a processed energy parameters and audio environment parameter for providing an indication of a type of said uncontrolled audio environment.

12. The learner of claim 9, wherein said timing and said energy learner are configured for operating in a predetermined time frame and for ceasing functioning when each decision logic unit of said timing learner and said energy learner is reaching a decision.

13. A method of controlling acoustic feedback of an audio terminal having a plurality of audio states which include at least a transmit audio state, at least a receive audio state and at least an idle audio state wherein the method comprising the steps of:
providing a first learner for learning the timing characteristics of said receive and transmit states for providing a first index;
manipulating said first index with a second index for identifying a type of uncontrolled audio environment of an said audio terminal; and
controlling said acoustic feedback of said audio terminal in accordance with said identification.

14. The method of claim 13, wherein said step of controlling further comprises the steps of:
a. setting said audio terminal in at least one state of said audio terminal state machine;
b. tuning said audio terminal in accordance with said audio environment.
c. transitioning to at least one other state of said audio terminal state machine; and
d. repeating steps (b) and (c) for at least one other state of said state machine.

15. The method of claim 14, wherein said audio terminal parameters comprises at least the parameters of:
a discrimination threshold between audio stream activity/energy ratios;
a set of attenuation values for the plurality of audio states of the state machine used on the receive and transmit audio streams; and
the hangover timings between state transition of said audio terminal state machine.

16. The method of claim 15, wherein said first index and said second index are numeric values.
